(19) United States
(12) Patent Application Publication
(10) Pub. No.: US 2024/0389816 A1
(43) Pub. Date: Nov. 28, 2024

(54) ROBOTIC SYSTEM FOR FACADE OPERATION OF A BUILDING FACADE AND THE METHOD THEREOF

(71) Applicant: Skybotics Technology Limited, Hong Kong (HK)

(72) Inventor: Dickson Chun Fung Li, Hong Kong (HK)

(21) Appl. No.: 18/675,358

(22) Filed: May 28, 2024

Related U.S. Application Data
(60) Provisional application No. 63/469,402, filed on May 28, 2023.

(51) Int. Cl. A47L 11/38; B64U 10/60; B64U 101/29; E04G 23/00

(52) U.S. Cl. CPC A47L 11/38; B64U 10/60; E04G 23/002; A47L 2201/00; B64U 2101/29

(57) ABSTRACT

Disclosed is a robotic system for facade operation of a building facade, including: a plurality of propelling elements on an unmanned aerial vehicle to enable the unmanned aerial vehicle to hover in any position for various tasks; one or more end effectors on the unmanned aerial vehicle to perform various tasks; and an enclosed system to confine the operation space of the unmanned aerial vehicle.

### CROSS-REFERENCE TO RELATED APPLICATIONS

The present application claims the benefit of U.S. Provisional Application No. 63/469,402, filed on May 28, 2023.

### BACKGROUND OF THE INVENTION

The present invention relates to a building facade operation with an unmanned aerial vehicle (UAV). More particularly, the present invention pertains to a system and method for facade operations of a building façade with an unmanned aerial vehicle.

Many aspects of infrastructure, including transportation, energy, heavy industry, mining, and aerospace, require inspection, maintenance, and repair. A key part of making these operations effective is to use non-destructive testing, which traditionally requires scaffolding, boom lifts, or gondolas. All methods put workers at risk or result in downtime for critical assets. Typical drone inspection systems cannot be used for non-destructive testing, as they require physical contact.

One typical example is facade inspection in Hong Kong which must be performed periodically to ensure the safety of the occupants and the public. Improper maintenance or poor inspection may lead to spalling concrete and result in debris falling, potentially causing damage to private and public property, even casualties. Currently, the inspections are conducted by humans and require scaffolding or gondolas. Workers will have to manually tap the wall and identify spalling concrete, debonding tiles, and delamination through its hollow tapping sound. However, such operations at height are dangerous for workers, frequently leading to injuries or even fatalities. Furthermore, the high setup cost of gondolas or scaffoldings implies room for improvement in building maintenance automation.

There are a few existing systems in the market that assist in building façade operations. However, to date, there are no comprehensive methods and systems that offer a holistic approach to address all aspects of façade construction, maintenance, and management seamlessly. Some of these examples are discussed in the following prior arts.

China patent publication no. 107440627A discloses a kind of captive unmanned plane high-altitude wall cleaning operation system and its method of work. The front of the unmanned plane is provided with an airborne cleaning device for being used for cleaning high-altitude walls. The High Altitude Platform equipment is positioned on the appropriate floor of roof or ground, and the High Altitude Platform equipment provides electric energy to the unmanned plane by air transmission pipe and provides cleaning fluid to the airborne cleaning device. The control station realizes the cleaning to wall by controlling the coordinated operation of the unmanned plane, the airborne cleaning device and the High Altitude Platform equipment. The beneficial effects of the invention are as follows: high-altitude wall cleaning operation and captive unmanned plane are organically combined, it possesses that highly stable, continuation of the journey when can be long during hovering, cleaning be quick and multiple features such as cost is cheap, manual work can be substituted, human resources are discharged, worker is freed from high-altitude safe risk. However, the system may not be able to operate continuously. Besides, the prior art may face challenges in completing tasks that require the unmanned plane to precisely hover in all positions, such as vertical movement. Additionally, the prior invention primarily emphasizes wall cleaning operations, overlooking numerous other facets integral to facade operations, including health checks and maintenance.

U.S. Pat. No. 11,529,036B2 discloses a robotic device for working on a surface includes a body including: a tool for working on the surface; a controller moving the body along the surface; a first set of at least two rotors mounted to the body and generating thrust in a first direction towards the surface; and a second set of at least two rotors mounted to the body and generating thrust in a second direction away from the surface. A sensor measures a distance between the body and the surface, and a computer adjusts the first set of rotors and the second set of rotors in response to the sensor to place the body in position to work on the surface. In particular, the first set of rotors and the second set of rotors generate a net force on the body to it in non-contact position to work on the surface. However, the system may not be able to operate continuously. Besides, there may be a higher risk of unauthorized access to the UAV's flight area. This could lead to safety concerns or compromise the security of sensitive operations. The prior art may lack safety measures as it relies on the thruster forces to approach the target with no adequate safeguards to surroundings for potential emergencies. Besides, this may also affect the stability of the system. The unmanned aerial vehicle might become less stable when objecting to the external disturbance force. For a contact-based inspection, physical interaction with the environment is essential. An unexpected collision might result in an accidental fall or even damage to the properties.

WIPO patent publication no. 2019040975A1 discloses an autonomous device for servicing the outside of buildings includes a vehicle that is suspended from and tethered to a positioning system secured to the building above the vehicle. The vehicle sends positioning signals to the positioning system to maneuver the vehicle, e.g. up/down and left/right over a panel within the confines of a border of the panel while servicing components service the panel. Once the panel is serviced, vertically disposed propellers are activated to push the vehicle off the building while the positioning system simultaneously positions the vehicle over the next target window. The propellers allow the vehicle to clear mullions and similar dividers. The vehicle may be a cleaning vehicle fitted with cleaning components such as cleaning disks, spray nozzles and a wiper blade. However, the system may not be able to operate continuously. The prior art may have limited capacity to carry payloads such as additional equipment, supplies, or materials. This can restrict its functionality and utility in various applications where carrying capacity is essential. Besides, the prior art is powered by batteries, which may limit their operation time and complicate the working procedures. Multiple batteries or chargers have to be prepared and the unmanned aerial vehicles have to land to charge or change batteries during operations.

Despite the existing inventions in the industries, there is still a need for a comprehensive system to assist in the façade building operations.

### SUMMARY OF THE INVENTION

It is an objective of the present invention to provide comprehensive robotic systems and methods for positioning an unmanned aerial vehicle (UAV) equipped with diverse end effectors, facilitating a range of operations such as facade inspection, window cleaning, concrete inspection, and other physical contact facade tasks, all designed to operate effectively for longer operation time.

It is also an objective of the present invention to provide versatile robotic systems and methods capable of hovering in any position to perform a multitude of tasks, including facade inspection, window cleaning, and other facade operations, while maximizing inspection area coverage and accessing inaccessible regions prone to corrosion and defects, such as areas under balconies, fins, and bay windows.

It is further an objective of the present invention to provide robotic systems and methods for various operations with different façade features or geometries, such as maintenance or inspection tasks to the low accessible building façade.

It is another objective of the present invention to provide safer robotic systems and methods that ensure safety of other buildings and pedestrians during accidents.

Accordingly, these objectives may be achieved by following the teachings of the present invention. The present invention relates to a robotic system and method for facade operation of a building facade, comprising: a plurality of propelling elements on an unmanned aerial vehicle to enable the unmanned aerial vehicle to hover in any position for various tasks; one or more end effectors on the unmanned aerial vehicle to perform various tasks; and an enclosed system to confine the operation space of the unmanned aerial vehicle.

### BRIEF DESCRIPTION OF DRAWINGS

The features of the invention will be more readily understood and appreciated from the following detailed description when read in conjunction with the accompanying drawings of the preferred embodiment of the present invention, in which:

FIG. 1 illustrates a robotic system including an unmanned aerial vehicle, a winch system, an enclosed system, and a ground station, according to an embodiment of the subject invention.

FIG. 2 shows the design of the unmanned aerial vehicle for inspection, comprising the end effector, propelling elements, suspending cable bundle, and vertical propelling elements, according to an embodiment of the subject invention.

FIG. 3 shows the operation procedures of the robotic system in the undercut and uneven areas of a building facade, according to an embodiment of the subject invention.

FIG. 4 shows the design of the unmanned aerial vehicle for cleaning, comprising the wiper, sprayer, and rotary brush, according to an embodiment of the subject invention.

FIG. 5 shows the annotated photo of the prototype of the unmanned aerial vehicle, according to an embodiment of the subject invention.

### DETAILED DESCRIPTION OF THE INVENTION

For the purposes of promoting and understanding of the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

As used herein, the singular forms “a,” “am,” and “the” are intended to include the plural forms as well as the singular forms, unless the context clearly indicates otherwise. Thus, for example, reference to “an arm” or “a hole” should be construed to cover or encompass both a singular arm or a singular hole and a plurality of arms and a plurality of holes, unless indicated otherwise or clearly contradicted by the context. Similarly, for example, reference to multiple “arms” or any plurality of “holes” should be construed to cover or encompass both a singular arm or a singular hole and a plurality of arms and a plurality of holes, unless indicated otherwise or clearly contradicted by the context. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention pertains. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Novel and useful robotic system designs, apparatuses, and methods for facade inspection are disclosed herein. In the following description, for purposes of explanation, numerous specific details are set forth to provide a thorough understanding of the present invention. It will be evident, however, to one skilled in the art that the present invention can be practiced without these specific details.

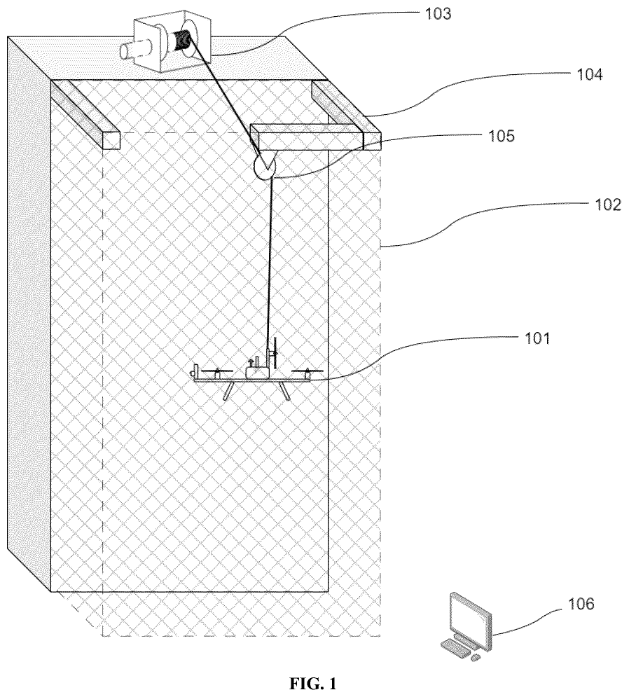

The present disclosure is to be considered as an exemplification of the invention and is not intended to limit the invention to the specific embodiments illustrated by the figures or the description below. The present invention will now be described by referencing the appended FIGS. 1 to 5 representing certain exemplary and non-limiting embodiments.

The present invention teaches a robotic system for facade operation of a building facade, comprising: a plurality of propelling elements 202 on an unmanned aerial vehicle 101 to enable the unmanned aerial vehicle 101 to hover in any position for various tasks; one or more end effectors 201 on the unmanned aerial vehicle 101 to perform various tasks; and an enclosed system to confine the operation space of the unmanned aerial vehicle 101. The unmanned aerial vehicle 101 is adapted to travel to a position along a building facade to conduct the required tasks such as inspection or cleaning. In some embodiments, one or more exits for the unmanned aerial vehicle 101 may exist.

In accordance with a preferred embodiment of the present invention, the propelling elements 202 include but are not limited to a vertical propelling element 203. The propelling elements 202 are configured to provide thruster force into a surface to be operated. The unmanned aerial vehicle 101 comprises one or more propelling elements 202. The propelling elements 202 include but are not limited to thrusters, duct fans, or propellers with motors. They can provide propelling force to lift the unmanned aerial vehicle 101 and enable the unmanned aerial vehicle 101 to hover at any desired position of the building and make physical contact to the facade. The vertical propelling element 203 is substantially orthogonal to the horizontal propelling element 202 to control the movement of the unmanned aerial vehicle 101. The vertical propelling element 203 is configured to provide an inward force, which drives the unmanned aerial vehicle 101 into and out of the façade plane.

One common configuration of cable robots is to suspend a robotic inspector by cables from the roof, usually by one or multiple cranes. The robotic inspector can be driven to the desired position by controlling the cable lengths. However, the problem is their inadequate coverage and inaccessibility to facades with features. Bay windows, balconies, air conditioners, and drying racks are usually installed on facades of residential buildings, leaving the area under them inaccessible by cable robots. Similarly, fins and extrusions of commercial buildings pose untackled challenges for cable robots. Moreover, they require access to the roof to set up the crane. It will pose some limitations for some buildings with solar panels, heat exchanger systems, or water pumps installed on the roof.

However, in contrast to the above issue, the present invention is able to maximize inspection area coverage and reaches inaccessible regions e.g., regions under balconies, fins, and bay windows that are vulnerable to corrosion and defects. The feature of the propelling elements 202 offers the ability to hover and deliver the inspection module to any desired position of the façade maintains minimal blind spots for a thorough inspection.

Further, the propelling elements 202 may be adapted to hover at a low accessible façade surface, and the vertical propelling elements 203 facilitate contact with the façade for contact and non-contact tasks. One or multiple extra vertical propelling elements 203, perpendicular to other propellers 202 are incorporated to provide a pressing force into the targeted surface to counteract the disturbance.

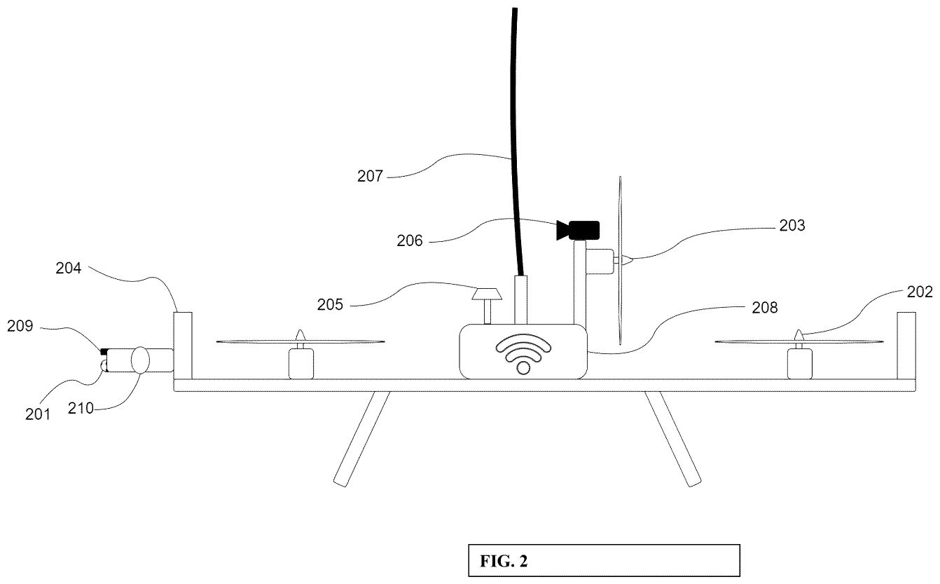

FIG. 2 provides an enlarged view of one embodiment of an unmanned aerial vehicle 101, comprising the end effector 201, propelling elements 202, and vertical propelling element 203 to enable facade inspection of a variety of buildings with different extrusions or geometries.

In certain embodiments, one or more vertical propelling elements 203 can exist to provide propelling forces in other directions, which can be perpendicular to the propelling element 202. The vertical propelling elements 203 can be used to maintain firm and stable contact with the façade for the tasks.

In accordance with a preferred embodiment of the present invention, the surface for performing tasks comprises building facade or windows with an irregular surface, different features, and extrusions. For various façade tasks, the surface to be operated could be in different orientations, which might not be vertical or horizontal. The prior art of unmanned aerial vehicles relies on the propellers to adjust the angle of the end effector 201, while the present invention can adjust the angle by one additional revolute joint which provides larger flexibility. It can achieve a large angle for the end effector 201, and thus a broader range of façade surface. Also, higher stability can be achieved by reducing the dependence and burdens of the propeller controllers.

In accordance with a preferred embodiment of the present invention, the tasks are performed via contact or non-contact. The robotic system may comprise a contact-based unmanned aerial vehicle 101 for façade operation.

In accordance with a preferred embodiment of the present invention, the unmanned aerial vehicle 101 comprises sliders or rollers to facilitate the contact and the sliding movement of the unmanned aerial vehicle 101 relative to the building. The incorporation of slider and shields 204 helps to assist the unmanned aerial vehicle 101 to slide on the façade to perform contact-based tasks, keeping gentle contact and moving at the same time. Shield 204 with rollers is included to facilitate contact with the building surface. The rollers on the shield 204 enable stable contact while allowing sliding motion parallel to the surface. In addition, it can protect the propelling elements 202 from colliding with the facade.

In accordance with a preferred embodiment of the present invention, at least one unmanned aerial vehicle 101 is connected to at least one winch system 103 for a safer environment and continuous operations. In some embodiment, one or more winch systems 103 may be installed into the roof, the cantilever, or the façade. Possible configurations include one unmanned aerial vehicle 101 connected to one winch system 103 or one unmanned aerial vehicle 101 connected to two or more winch systems 103. Alternative configurations can include more than one unmanned aerial vehicle 101 connected to one winch system 103 or more than one winch systems 103 working in the same enclosed system. Exemplary and non-limiting embodiments can provide 1, 2, 3, 4, 5, or more winch systems 103 working separately or together in sequential or parallel configuration, or combinations thereof, as appropriate to the size and confirmation of the building and the winch system 103, to support and position 1, 2, 3, 4, 5, or more unmanned aerial vehicle 101.

In accordance with a preferred embodiment of the present invention, the winch system 103 comprises electric motors, brakes, cable drums, electric slip rings, hydraulic slip rings, cable guiding pulleys, and lead screws. The winch system 103 provides power, electric signal, and materials and arrests the unmanned aerial vehicle 101 during accidental falls.

In accordance with a preferred embodiment of the present invention, the end effector 201 comprises at least one array of non-destructive testing (NDT) sensors for inspection.

For certain embodiments that can conduct the concrete inspection, the inspection end effector 201 is incorporated. The tapping gear in the inspection end effector 201 automatically taps the facade surface. The audio signal of the tapping sound is collected by the microphone for analysis. Through analyzing the inspection data of the façade, a concrete health report, including a map, checklist, or inspection punchlist, is generated for the guidance of follow-up actions.

In certain embodiments, sensing end effector 201 is incorporated to perform the inspection tasks. It may be used to locate cracks, voids, delamination, debonding plastering, and other defects in masonry structures. In certain embodiments of the sensing end effector 201, it measures concrete health in a non-destructive way and evaluates the façade in a contact or non-contact way. A revolute joint 210 is incorporated to adjust the angle of the end effector 201 for inspection of the surface at different angles.

In accordance with a preferred embodiment of the present invention, the end effector 201 comprises at least one wiper 403, rotary brushes 402, sprayers 401, and vacuum cleaners 404.

In accordance with a preferred embodiment of the present invention, the robotic system further comprises an odometry sensing system and the odometry sensing system comprises light detecting and ranging (LIDAR) sensor, ultrasonic sensor, optical flow sensor, or Global Positioning System (GPS) sensors. Contact sensor 209 is configured to ensure gentle contact with the desired distance to the wall surface. Localization sensor 205 is incorporated to provide absolute or relative position from the façade, which can include satellite navigation (GNSS) systems with or without real-time kinematic positioning, ultra-wideband (UWB) Positioning system, ultrasonic sensor, laser sensor, LIDAR sensor system, as well as other positioning systems know in the art.

One or more cameras 206 are incorporated into the unmanned aerial vehicle 101 to monitor the tasks and provide visual video for the users. In some embodiments, Red, Green, Blue (RGB) cameras or infra-red cameras are used for visual inspection of the building to identify visible defects or thermal abnormalities. Most unmanned aerial vehicles in the market carry various RGB or infrared cameras to take high resolutions images to determine surface cracks, without making any contact with the façade surface.

In accordance with a preferred embodiment of the present invention, the enclosed system is made by fencing with one or multiple layers of safety net to ensure the safety of other buildings, pedestrians and public properties during operations or accidents. The enclosed system is to confine the operation space of the unmanned aerial vehicle 101. In case of emergencies, the safety netting can capture the drone. The net is supported by the cantilever beam 104, other hooks, or strings, which are built from the facade or the roof of the building and other places. The shape and the geometry of the safety is to be modified by fixtures or pulling cable.

FIG. 1 depicts an isometric view of a system for conducting facade operations with the robotic system (the “system”) according to various embodiments of the present invention. FIG. 1 includes an unmanned aerial vehicle 101, safety netting 102, and winch system 103. Referring to FIG. 1, in the embodiment shown, the structure or building for the operation is enclosed by a safety netting 102 to act as a fence and the unmanned aerial vehicle 101 can operate inside the enclosed system.

The other unmanned aerial vehicles in the market that can perform contact-based tasks do not have the safety net to ensure safety. Almost all the unmanned aerial vehicles in the literature can hover in any position without any confinement. Although they have a larger flexibility to travel to another building or structure, they scarify safety and may lead to accidents for the public assets or even pedestrians.

The present invention further teaches a robotic system for facade operation of a building facade, comprising: one or more suspending cable bundles 207 that is configured to provide driving force, deliver electricity or materials to an unmanned aerial vehicle 101; a plurality of propelling elements 202 fixed to the unmanned aerial vehicle 101 to enable the unmanned aerial vehicle 101 to hover in any position for various tasks; and one or more end effectors 201 fixed to the unmanned aerial vehicle 101 to perform various tasks. The incorporation of the suspending system is to assist in coordinating the unmanned aerial vehicle 101. The suspending system provides extra safety support and power supply to the robotic unmanned aerial vehicle 101.

For other unmanned aerial vehicles in the literature, only wired supply from mobile robots can be seen, where the wire is lower than the unmanned aerial vehicle 101. For the present invention, the wired supply is provided from a fixed structure. Unique advantages can be conceived due to the wired supply from the fixed structure built on the top of the whole flight zone. The fixed structure can confine the whole flight area, which simplifies the wire routing and, more importantly, acts as a safety wire to arrest the robotic unmanned aerial vehicle 101 during accidents. It further enhances the safety of the whole system, as a contact based robotic unmanned aerial vehicle 101.

As the fixed structure is built on top of the flight zone, the system requirement on the pipes and pump can be lower for liquid delivery. With the help of gravity, the power and pressure required for the pumping system are lower, which can then reduce the pipe size, weight, and material requirements.

In accordance with a preferred embodiment of the present invention, the suspending cables bundles 207, wires, or tubes are configured to provide supporting force, supply power, or liquids.

In certain embodiments, the cable bundles 207 are used to carry the unmanned aerial vehicle 101, supply power, electric signal, and liquid. For certain instances, once the propelling elements 202 are deactivated and the cable bundles 207 capture the unmanned aerial vehicle 101 to avoid falling. Power and the electrical signal are supplied to the onboard computing unit 208, actuators, and sensor. The onboard computing unit 208 may be one or more computers, microcontrollers, or a combination of those. It should also be understood that both wired communication or/and wireless communication can be used to connect with the ground station computer.

In accordance with a preferred embodiment of the present invention, at least one unmanned aerial vehicle 101 is connected to at least one winch system 103 that is configured to wind the suspending cable bundles 207 and control the length of the suspending cable bundles 207. The winch system 103 comprises electric motors, brakes, cable drums, electric slip rings, hydraulic slip rings, cable guiding pulleys, and lead screws.

The winch system 103 is able to drive a bundle of wires, electric cables, or pipes. The wires provide some supporting force to support the weight of the electric cable and pipes. The electric motors are adapted to drive the cable drum and the brakes can stop the cable drum to avoid accidental falls during failure. The electric slip rings and hydraulic slip rings enable power transmission, electrical signals, and liquid delivery from an immobile to a revolving cable drum. The cable guiding pulleys, and lead screws adjust the cable outlet and guide the cable.

The winch system 103 of the present invention retracts the excess length of the cable bundle 207 when the unmanned aerial vehicle 101 is moving upward. In particular, the winch system 103 is adapted to maintain the length of the suspending cable bundles 207 such that the suspending cable bundles 207 is prevented from being caught by the vertical propelling element 203. As the prior art does not have any vertical propelling element 203, the prior art document cannot teach or direct a person skilled in the art to apply a winch system 103 to prevent the cable bundle 207 from being caught by the vertical propelling element 203.

Further, a pulley routing system 105 exists in the present invention to route the bundle of cables and wires from the winch 103 to the unmanned aerial vehicle 101. In case of emergencies, the propelling element 202 of the unmanned aerial vehicle 101 can be disabled and the winch 103 can be braked to hang the unmanned aerial vehicle 101. It can also arrest the unmanned aerial vehicle 101 from accidental falls. The electric cables can transmit electric signals or power the unmanned aerial vehicle 101 for prolonged operation time, and the pipes can supply paint, water, cleaning detergents, or other aqueous substances for wall painting, window cleaning, or other tasks. One end of the bundle 207 is connected to the unmanned aerial vehicle 101, while the other end can be connected to the electric pump or power socket on the roof. The motor of the winch 103, the pump, and the unmanned aerial vehicle 101 can be powered by the alternating current power supply or direct current power supply.

Ground station controller 106 is used to control and monitor the coordinated motion of the unmanned aerial vehicle 101 and the winch 103. The user can control one or multiple drones operating in the enclosed system, as fenced by the safety netting, to speed up the operation. The wired or wireless communication protocol can be adopted, and the signal can be transmitted by the wire bundle for wired communication protocol.

In accordance with a preferred embodiment of the present invention, the propelling elements 202 include but are not limited to a vertical propelling element 203. The propelling elements 202 defined may be the horizontal propelling elements 202 alone or along with the vertical propelling elements 203. With the presence of the vertical propelling element 203, the configuration of the cable bundle 207 and the camera 206 are carefully designed such that they will not hinder or obstruct the operation of the vertical propelling element 203 as shown in FIG. 2. In particular, the blades of the vertical propelling element 203 are facing away from the cable bundle 207 and the camera 206. These configurations are not disclosed or anticipated in the prior art documents and are considered to be a unique structural design so as to provide a suitable operation of the unmanned aerial vehicle 101, without the risk of self-obstruction.

In accordance with a preferred embodiment of the present invention, the end effector 201 comprises one or more array of non-destructive testing (NDT) sensors for inspection.

In accordance with a preferred embodiment of the present invention, the end effector 201 comprises one or more wipers 403, rotary brushes 402, sprayers 401, and vacuum cleaners 404.

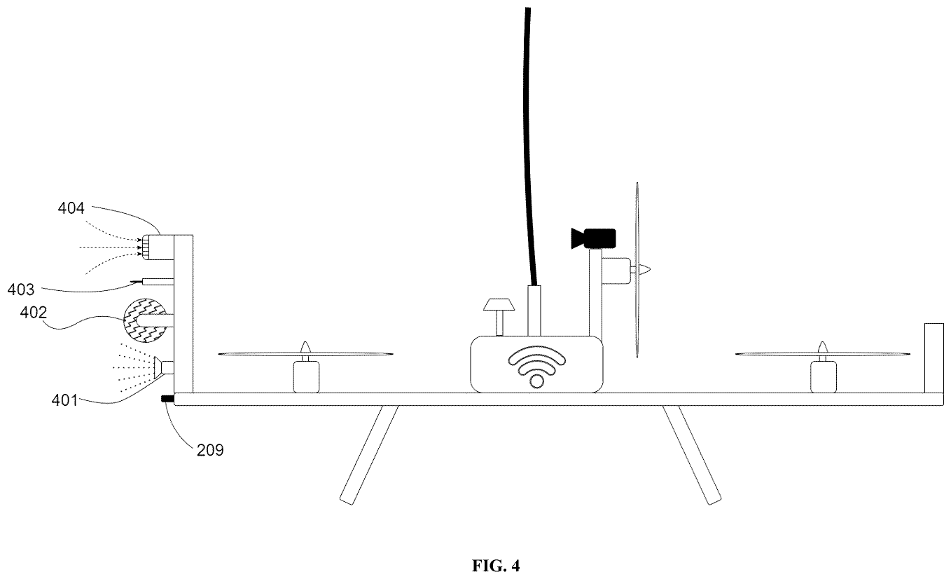

In other embodiments, the unmanned aerial vehicle 101 can carry the sprayer 401 with or without the wiper 403 for façade or window cleaning. FIG. 4 depicts the embodiment for façade or window cleaning, containing the sprayer 401, rotary brush 402, and wiper 403. The sprayer 401 comprises a nozzle to dispense detergent or water to the façade and the window. Water pumps can be located on the roof whilst the unmanned aerial vehicle 101 to provide water pressure for spraying, and the cable bundle 207 can supply the water or the detergent. One example operation procedure can be spraying detergent on the façade, followed by scrubbing with a rotary brush 402 and an optional procedure of spraying water. The procedure is repeated a few times to clean the stains or dirt. Window wiper 403 or vacuum cleaner 404 is used to remove the remaining moisture from the facade or window. Similar to the operational procedure of inspection, a zigzag path can be adopted for a thorough cleaning of the whole façade or window curtain.

For some embodiment for the painting task, a similar configuration can be kept e.g. keeping the sprayer 401 and changing the water pump into a paint oil pump. The unmanned aerial vehicle 101 can paint the facade surface by spraying the façade with paint, which can be used for marking specific areas or painting the whole façade.

Besides, the present invention uses vertical propelling element 203 to counterbalance the thruster forces induced by the sprayer 401 and the vacuum cleaner 404 such that the unmanned aerial vehicle 101 can maintained operating within an enclosed space. The vertical propelling element 203 can counteract the thruster forces induced when operating the sprayer 401 and the vacuum cleaner 404 in a more efficient manner than the four horizontal propelling elements 202 or the equivalent in the existing inventions. As such, this unique arrangement is devised to ensure, or at least attempt, to achieve that the vertical propelling element 203 is a more efficient mechanism to control the unmanned aerial vehicle 101 for cleaning with sprayer 401 or vacuum cleaner 404 within an enclosed space.

In some scenarios, the vertical propelling element 203 may need to generate an outward thruster force to counterbalance the forces induced by the vacuum cleaner 404 instead of inward forces.

Substantially, the present invention accrues significant advantages from the incorporation of the vertical propelling element 203, alongside the innovative mechanism for controlling the unmanned aerial vehicle 101 within enclosed spaces during the operation of a sprayer 401 or vacuum cleaner 404 using the same vertical propelling element 203.

The present invention also discloses a method for conducting facade operation of a building facade using a robotic system, comprising: acquiring visual images of the building; converting the images into virtual models; using the virtual models to guide the operation; and indicating one or more specific areas of interest for operation.

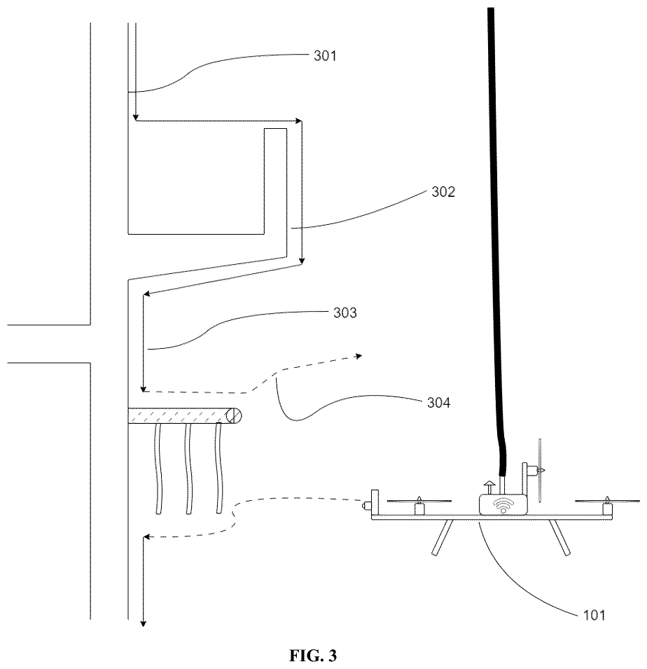

FIG. 3 depicts the operation of the unmanned aerial vehicle 101 during inspection tasks, containing the facade to be inspected 301, extrusions and features of the façade 302, the path of inspection 303, and the path of hovering 304. The operation of the unmanned aerial vehicle 101 can be divided into two stages. Firstly, the unmanned aerial vehicle 101 can take off and hover to the starting point for the operation, by activating and controlling the propelling elements 202. The unmanned aerial vehicle 101 can approach the façade surface, enabling contact between shield 204 to the façade surface. It can be achieved by the action of propelling element 202 alone or also with the aid of vertical propelling element 203. The vertical propelling element 203 can provide an inward force, which drives the unmanned aerial vehicle 101 into or out of the facade plane. It can provide a stabilizing force to withstand the disturbance and provide essential force for the required tasks. The contact sensor 209 would be activated to obtain data on the relative distance from the façade. Maintaining gentle contact with the façade, the unmanned aerial vehicle 101 can slide to the next position for the next measurement. It should be understood that measurements can be taken during sliding for a finer resolution between measurement points. The next measurement can be made after the unmanned aerial vehicle 101 reached the next position. The process repeats until it meets the façade features 302. The façade features 302 can be bay windows, balconies, fins, air conditioners, drying racks, or other features that may block the path. In this way, the unmanned aerial vehicle 101 can detach from the facade, as denoted by path 304. It can hover to the next position below or next to the features to continue the measurement. A similar workflow can be adopted for the regions where inspection is not required. It can include windows, glass claddings, metallic claddings, or other claddings. The measurement continues until one vertical column of the facade is inspected, and the unmanned aerial vehicle 101 can start another column by detaching and hovering to the top positions of the next column.

For features with inclined surfaces to be inspected that are not parallel to the end effectors 201, another strategy can be adopted. For certain embodiments, one or more rotational joints 210 can be incorporated into the end effector 201 to adjust the facing angle of the end effector 201. Examples include underneath areas of the balconies or fins, facing the ground. The end effector 201 can be rotated 90 degrees, making the end effector 201 normal to the surface to be inspected.

For a thorough inspection conducted to the whole facade, a zigzag path can be adopted. The façade can be divided into columns of the vertical path, while the unmanned aerial vehicle 101 can follow each vertical path for inspection. After finishing one path, it can proceed to the next one by detaching and hovering at it.

In accordance with a preferred embodiment of the present invention, the method further comprising distributing one or more specific areas of interest for operation into the virtual models of the building facade.

In accordance with a preferred embodiment of the present invention, the method further comprising inspecting the building; and identifying visible defects or thermal abnormalities.

In accordance with a preferred embodiment of the present invention, the method further comprising performing at least one pre-determined task via contact or non-contact; and monitoring the pre-determined task.

### Materials and Methods

All patents, patent applications, provisional applications, and publications referred to or cited herein are incorporated by reference in their entirety, including all figures and tables, to the extent they are not inconsistent with the explicit teachings of this specification. Following are examples that illustrate procedures for practicing the invention. These examples should not be construed as limiting. All percentages are by weight and all solvent mixture proportions are by volume unless otherwise noted.

### Example

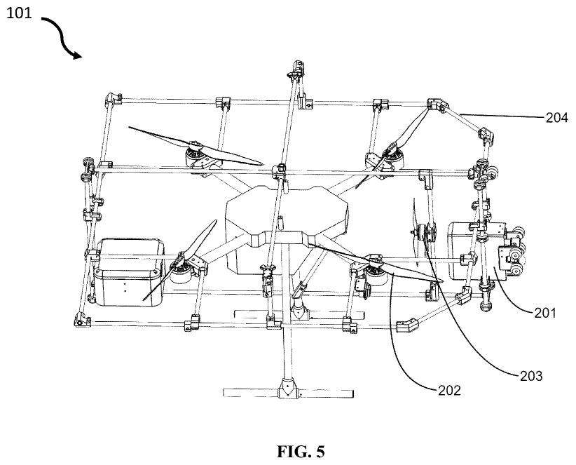

A prototype robot system to perform facade operations in accordance with the subject invention is presented. FIG. 5 provides the front view of the unmanned aerial vehicle 101, containing the propelling elements 202, an inspection end effector 201, vertical propelling elements 202, a camera, and GPS antennas of the satellite navigation (GNSS) system. The unmanned aerial vehicle 101 can hover at the desired position of the façade and make physical contact with the façade. The inspection end effector 201 can then conduct a contact-based inspection. The shield 204 can prevent the propelling elements 202 from colliding with the façade surface while enabling the unmanned aerial vehicle 101 to make contact and slide on the façade. The vertical propelling element 203 can provide a pressing force into the façade surfaces to stabilize the unmanned aerial vehicle 101 and resist external disturbance. As enabled by the satellite navigation (GNSS) system, the unmanned aerial vehicle 101 can send back its position with the inspection result. The positional data and the inspection result can then be gathered to generate a digital inspection report.

The system and method in the present invention is novel by having the vertical propelling element 203, enclosed system arrangement, and winch system, which works together with the unmanned aerial vehicle 101 concerned. The unique structural arrangements in the unmanned aerial vehicle 101 (e.g., the propelling elements 202) together with a guide cable which is operated on a winch are novel and are not in any way suggested or directed to by any of the revealed prior art.

It should be understood that the examples and embodiments described herein are for illustrative purposes only and that various modifications or changes in light thereof will be suggested to persons skilled in the art and are to be included within the spirit and purview of this application and the scope of the appended claims. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

The present invention explained above is not limited to the aforementioned embodiment and drawings, and it will be obvious to those having an ordinary skill in the art of the prevent invention that various replacements, deformations, and changes may be made without departing from the scope of the invention.

1. A robotic system for facade operation of a building facade, comprising:
a plurality of propelling elements on an unmanned aerial vehicle to enable the unmanned aerial vehicle to hover in any position for various tasks;
one or more end effectors on the unmanned aerial vehicle to perform various tasks; and
an enclosed system to confine the operation space of the unmanned aerial vehicle.

2. The robotic system for facade operation of a building facade according to claim 1, wherein the propelling elements include but are not limited to a vertical propelling element.

3. The robotic system for facade operation of a building facade according to claim 2, wherein the propelling elements are configured to provide thruster force into a surface to be operated.

4. The robotic system for facade operation of a building facade according to claim 3, wherein the surface for performing tasks comprises building facade or windows with an irregular surface, different features, and extrusions.

5. The robotic system for facade operation of a building facade according to claim 4, wherein the tasks are performed via contact or non-contact.

6. The robotic system for facade operation of a building facade according to claim 1, wherein the unmanned aerial vehicle comprises sliders or rollers to facilitate the contact and the sliding movement of the unmanned aerial vehicle relative to the building.

7. The robotic system for facade operation of a building facade according to claim 6, wherein at least one unmanned aerial vehicle is connected to at least one winch system.

8. The robotic system for façade operation of a building facade according to claim 7, wherein the winch system comprises electric motors, brakes, cable drums, electric slip rings, hydraulic slip rings, cable guiding pulleys, and lead screws.

9. The robotic system for facade operation of a building facade according to claim 1, wherein the end effector comprises at least one array of non-destructive testing (NDT) sensors for inspection.

10. The robotic system for facade operation of a building facade according to claim 1, wherein the end effector comprises at least one wiper, rotary brushes, sprayers, and vacuum cleaners.

11. The robotic system for facade operation of a building facade according to claim 1, wherein the robotic system further comprises an odometry sensing system and the odometry sensing system comprises light detecting and ranging (LIDAR) sensor, ultrasonic sensor, optical flow sensor, or Global Positioning System (GPS) sensors.

12. The robotic system for facade operation of a building facade according to claim 1, wherein the enclosed system is made by fencing with one or multiple layers of safety net.

13. A robotic system for facade operation of a building facade, comprising:
one or more suspending cable bundles that is configured to provide driving force, deliver electricity or materials to an unmanned aerial vehicle;
a plurality of propelling elements fixed to the unmanned aerial vehicle to enable the unmanned aerial vehicle to hover in any position for various tasks; and
one or more end effectors fixed to the unmanned aerial vehicle to perform various tasks.

14. The robotic system for facade operation of a building facade according to claim 13, wherein the suspending cables bundles, wires, or tubes are configured to provide supporting force, supply power, or liquids.

15. The robotic system for facade operation of a building facade according to claim 13, wherein the unmanned aerial vehicle comprises sliders or rollers to facilitate the contact and the sliding movement of the unmanned aerial vehicle relative to the building.

16. The robotic system for facade operation of a building facade according to claim 15, wherein at least one unmanned aerial vehicle is connected to at least one winch system that is configured to wind the suspending cable bundles and control the length of the suspending cable bundles.

17. The robotic system for façade operation of a building facade according to claim 16, wherein the winch system comprises electric motors, brakes, cable drums, electric slip rings, hydraulic slip rings, cable guiding pulleys, and lead screws.

18. The robotic system for facade operation of a building facade according to claim 13, wherein the propelling elements include but are not limited to a vertical propelling element.

19. The robotic system for facade operation of a building facade according to claim 18, wherein the propelling elements are configured to provide thruster force into a surface to be operated.

20. The robotic system for facade operation of a building facade according to claim 19, wherein the surface for performing tasks comprises building façade or windows with an irregular surface, different features, and extrusions.

21. The robotic system for facade operation of a building facade according to claim 20, wherein the tasks are performed via contact or non-contact.

22. The robotic system for facade operation of a building facade according to claim 13, wherein the end effector comprises one or more array of non-destructive testing (NDT) sensors for inspection.

23. The robotic system for facade operation of a building facade according to claim 13, wherein the end effector comprises one or more wipers, rotary brushes, sprayers, and vacuum cleaners.

24. The robotic system for facade operation of a building facade according to claim 13, wherein the robotic system further comprises an odometry sensing system and the odometry sensing system further comprises light detecting and ranging (LIDAR) sensor, ultrasonic sensor, optical flow sensor, or Global Positioning System (GPS) sensors.

25. A method for conducting facade operation of a building facade using a robotic system, comprising: acquiring visual images of the building; converting the images into virtual models; using the virtual models to guide the operation; and indicating one or more specific areas of interest for operation.

26. The method according to claim 25, the method further comprising distributing one or more specific areas of interest for operation into the virtual models of the building facade.

27. The method according to claim 25, the method further comprising inspecting the building; and identifying visible defects or thermal abnormalities.

28. The method according to claim 26, the method further comprising performing at least one pre-determined task via contact or non-contact; and monitoring the pre-determined task.
